(19) United States
(12) Patent Application Publication
(10) Pub. No.: US 2005/0252702 A1
(43) Pub. Date: Nov. 17, 2005

(54) Fish cycle, a non-traditional battery powered children ride-in vehicle

(76) Inventor: Marrell Haney, Chicago, IL (US)

Correspondence Address: Marrell Haney, 1301 West 96th Street, Chicago, IL, 60643, US

(21) Appl. No.: 11/130,711

(22) Filed: May 17, 2005

Related U.S. Application Data
(60) Provisional application No. 60/571,637, filed on May 17, 2004.

(51) Int. Cl. B60K 1/00

(52) U.S. Cl. 180/65.1

(57) ABSTRACT

The fish cycle is a non-traditional children ride-in playground car. It has an unusual body style that consists of plastic, and other materials such as batteries, electric motors and aluminum steel. Some preferred embodiments of the four wheel vehicle are tubeless rubber-base tires and a convertable top being adapted to roll or slide back into a rear storing compartment. The present invention is maneauverable with the use of a steering wheel or handle bars by connecting the steering chassis gear to the steering wheel component which is adapted to turn both wheels at the same time. The vehicle is powered by a combination of component devices including an electrically rechargable battery source, electric motors, pulley belts-driven drive shaft in the absent of wheel-driven driveshafts for each rear wheel. The cycle car is provided with a front and back seat, two right side doors,a left side passenger door and a rear door which is adapted to be pivoted vertically with spring adapted rods that open the door to a horizontal plane. The embodiment includes an in-dash with radio and CD player, front and rear lights, a horn and an on/off switch providing ignition and a stopping mechanism.

### This application claims priority of Provisional Application

| | |
|---|---|
| Appl:No. | 60/571,637 |
| Filed: | May 17, 2004 |

Int-Cl . . . A63H, 17/273,17/32,29/00,446/457
U.S. Cl . . . 446/297,298, 446/90,91,97,446/279,446/
288, 446/409,446/288,446/57,446/471,470

### PRIOR ART

| | | |
|---|---|---|
| 717,202 | December 1902 | Hobsch . . . 273/86A |
| 2,248,214 | July 1941 | Bleeker . . . 446/354 |
| 2,566,141 | August 1951 | Poli . . . 446/288 |
| 3,199,249 | August 1965 | Carver et.al . . . 446/290 |
| 3,536,354 | October 1970 | Ingram |
| 4,135,948 | February 1981 | Knibbs |
| 3,825,256 | December 1992 | Ochi . . . 273/86 |
| 5,221,226 | June 1933 | Park . . . 446/353 |
| 5,195,920 | March 1993 | Collier . . . 446/484X |
| 5,924,713A | July 1999 | Li . . . 280/270 |
| 5,697,621A | December 1997 | Nazarian . . . 280/1,165 |

### BACKGROUND OF THE INVENTION

1. Field of the Invention

The present invention relates to a children ride-in vehicle and more particularly to a ride-in vehicle adapted with non-traditional body shape or form and exceedingly suited for amusement and enjoyment for young children.

2. Brief Description of the Prior Art

A wide variety of children ride-in cars have been developed for children to learn driving skills and, at the same time, amuse themselves while at play.

### OBJECTS OF THE INVENTION

It is an object of the invention to provide an attractive and fun vehicle for young children and as described is especially well adapted and suitable for children play and amusements.

Another object of the invention is to provide a children ride-in vehicle of the character described having front and rear power source interconnected to provide function in tandem and sometimes separately from each other device. Still another object of the present invention is to provide new and improved electrically powered vehicle having a convertable top adapted to be opened by retracting it manually to a rear compartment; and a front and back seat being suitable to accommodate several small children.

Another object of the present invention is to provide a children fun vehicle with some non-traditional features and shape in body style of the character described having two front wheels on an axle device adapted to tirn in tandem by manually maneuvering the stirring wheel.

Still another object of the present invention is to provide a children fun car and playground vehicle of the character described having an entertainment system consisting of a radio and CD player and a rear and front light component adapted to function as means for entertainment and more skill development.

Another object of the present invention is to provide a children ride-in vehicle of the character described having a driveshaft erected onto the rear chassis/axle devices adapted to operate the rear wheels with chassis pulley belts. The system provides for a driveshaft being attached to each side of the rear axle, and being powered by small electric motors.

Yet another object of the present invention is to provide a children ride-in non-tradition vehicle for playground use of the character described having cushion seats covered with naugahyde for comfort and style.

### SUMMARY OF THE INVENTION

The foregoing and other objects and advantages of the present invention are achieved in a new and improved methodology in providing a children ride-in playground and amusement vehicle by way of representation which comprises a body with a convertable top having three passenger doors and a rear utility door. It has a rear end power plant and a front end power source designed with wiring, batteries that are installed on the inside of a plastic motor device having a sound device that is somewhat similarly to that of a real motor.

The front wheels are adapted to rotate in tandem on a shaft/axle device. A stirring wheel or handle bars are suitable devices for maneuvering the vehicle. Special belts are preferably used to activate the driveshaft that is located on each side of the chassis device, providing connection and power to the rear axle. In addition to the entainment system, having a radio and CD player, the children ride-in playground and amusement vehicle provides a convertable top that is adapted to slide or roll back into a storing compartment that is located behind the back seat area. The front wheels are spaced apart approximately 12 inches having rotation function from the same shaft/axle component. The vehicle provides a new and improved amusement component in its non-traditional shape and form including front and rear exterior lights.

### BRIEF DESCRIPTION OF THE DRAWINGS

The present invention can be more clearly understood by reference to the following description and accompanying drawings in which:

FIG. 1 is a perspective view of a non-traditional children ride-in vehicle for amusement and playground activities;

FIG. 2 is a perspective view of a chassis according to the present invention.

FIG. 3 is a perspective view of a front end chassis according to the present invention.

### DETAILED DESCRIPTION OF THE DRAWINGS

Referring now more particularly to the drawings their in is illustrated in a more improved children ride-in amusement and playground vehicle in which;

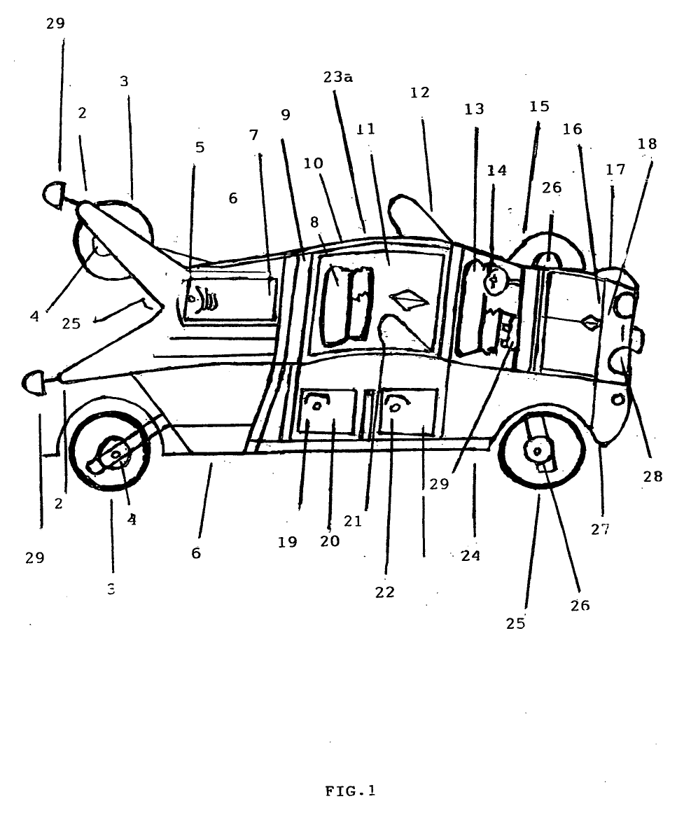

FIG. 1 shows a children ride-in non-traditional playground car 10 having a fish shaped body 12 and 23 with finns that pivot vertically above the top section of the vehicle 10 a plurality of wheels, 3 and 26 front section, that are adapted to rotate on axles 4 and 26. The vehicle 10 having a passenger door 23a on the left side, attached to the body with 2 inches hinges, and two passenger doors 20 and 23 on the right sides; being attached to the body with 2 inches hinges to provide for pivoting the doors horizontally in both directions.

Provided is rear door 5 adapted to pivot vertically with the aid of spring adapted rods 6 to the top horizontal plane at the border line of the rear door 6, and is attached with two hinges. Provided are rear wheels 3 suitable for attaching to rear axle with lock nuts and washers 4. Wheels are adapted with tubeless tires. Tail lights 24 that adapted to function are attached to finns 2, with nuts and bolts adapted for attaching to finns 2 and pivot out at least 1 inch. Provided are finns 2 12 and 21 which are component cone-shaped devices, to body 10 and originally attached as part of vehicle design. The right side panel 6 and the left side panel 6 (not shown) are both parts of vehicle design. Rear door 7 is section for spring/rod 6 attachment. Vehicle 10 provides a two passenger seating arranged on a horizontal line between the front doors and having a second seat erected behind the front seats.

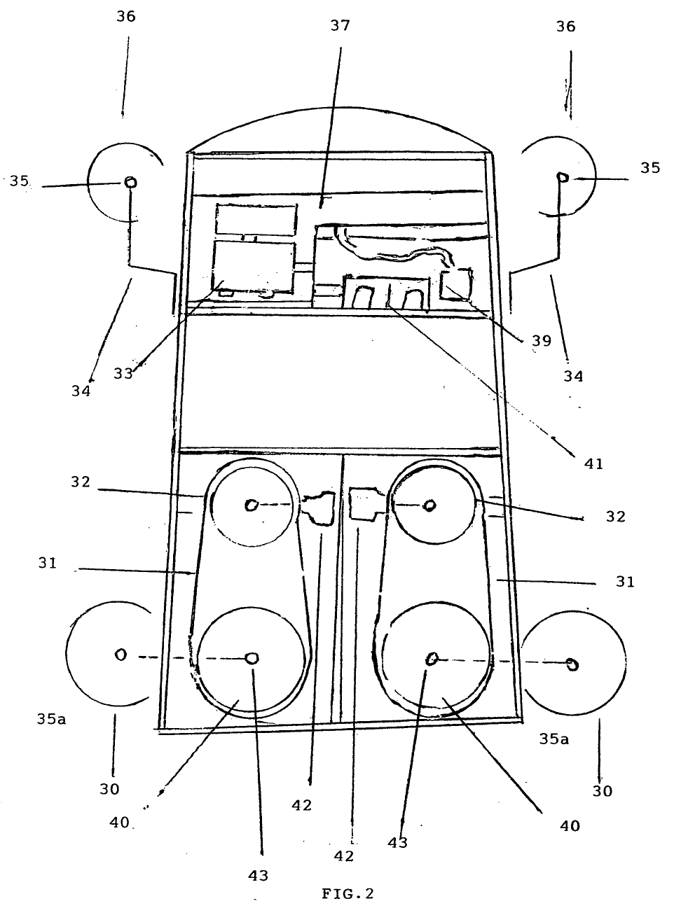

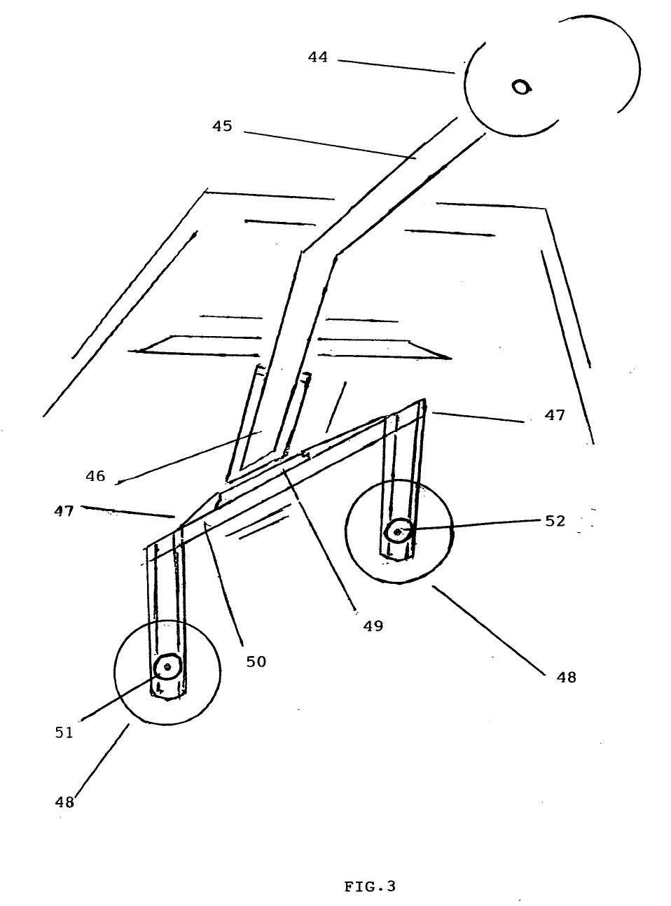

Preferably, second seat 8 and first seat 13 are provided with foam paddings and covered with naugahyde; a convertable cloth top 11 having a rear storing compartment 9 to be used when the the top 11 is pivoted on slide railings,erected on each side of top frame, which allows the top 11 to be roll back into storing compartment 9. Vehicle 10 is provided with stirring wheel 14 which have connection to front axle that is adapted for turning wheels in tandem. Plastic or metal fasteners such as screws and nuts/bolt combination may be suitable for containing wheel 15 onto axle FIG. 3, the front end power source 16 is housed underneath hood 16a which contain items such as switches, sound devices, wiring and batteries, on the inside of a plastic motor which have an exterior outlet for recharging the batteries. The left side front fender 17 and the right side front fender 27 are adapted for functionable lights as complements to head lights 28 on grille 18 which are also functionable. Entertainment system 29 is provided with a radio and CD player that are installed in in-dash that is at the dashboard vehicle 10. The fender panels on the left and right sides being body designs meet left and right sides doors at vertical line that separates to accommondate the connection of passenger doors 20, 23 and left side passenger door (not seen). Doors 20 and 23 are attached to vertical door bars with 2 inches hinges; All doors are adapted with non-locking devices 19, 22 and 5. Vehicle 10 is provided with chasis 25 as seen in FIG. 2.

Referring to FIG. 2 is a chassis adapted for vehicle 10 of which a stirring mechanism FIG. 2 is provided, a first power source 37 contains batteries, wiring, switches and sound device component inside of a plastic motor device, designed with exterior outlet, a device for recharging the batteries. Front wheels 36 and rear wheels 36a are attached to axles. Front axle 35 are adapted for rotating wheels in tandem to a left or right position according with axle design FIG. 3 from a connecting extending axle mechanism 34 which joins together onto front end stirring wheel column at the center of chassis devices 46, 47 and 49. Sound device 41, switches 38 and batteries 33 are all first power components and providing current to electric motors 42 which are adapted for rotating driveshafts 32. Pulley belts 31 are provided for driveshafts 32 which connect to wheels 30 with locking devices including wheel nuts and washers at point 35a. Each driveshaft is attached to the walls of the chassis with metal screw devices. The driveshafts containing several pulley wheels which rotate as specified for use vehicle 10 as a second source for manipulating wheels 3 and 30.

Referring to FIG. 3 is a front chassis design for manipulating front wheels 15 and 48 which connect to axle having a vertical bar that pivots upward to axle main bar connector and suspension bar which is on a horizontal line and having connecting plates 49 and 50 for vertical rotary stirring column 46 which thereby cause the wheels to turn in tandem. stirring wheel 44 and stirring column 45 are for illustration use as components of the front end stirring system. Vehicle 10 is adapted for various size and dimensions in according with present invention goal to provide a non-traditional amusement and playground vehicle for young children. Plastic, aluminum steel, foam paddings, naugahyde, and screws are some materials that are suitable for building vehicle 10. The process of molding can be useful in shaping and pairing plastic materials for the invention.

1. A vehicle that is shaped differently from traditional children playground cars;
a children playground vehicle with a convertable top that is adapted to be open by sliding the top to the rear compartment;
a passenger door on the left side and two passenger doors on the right side;
a in-dash with entainment system having radio and CD player;

2 The fish cycle, a non-traditional battery powered children amusement and playground car comprising;
a section where cone-shaped finns are pivoted horizontally from the trunk area;
a non-traditional battery powered vehicle for children having functionable windshield wipers and front and rear exterior lights.
